(19) United States
(12) Patent Application Publication
(10) Pub. No.: US 2007/0264606 A1
(43) Pub. Date: Nov. 15, 2007

(54) ORTHODONTIC BRACKET WITH REMOVABLE SLOT COVER

(75) Inventors: Chris Muha, Centennial, CO (US); David Wolf, Lakewood, CO (US); Daphne Upchurch, Lakewood, CO (US); Leon Laub, Fort Collins, CO (US); Robert Rudman, Denver, CO (US)

Correspondence Address: SHERIDAN ROSS PC, 1560 BROADWAY, SUITE 1200, DENVER, CO, 80202, US

(73) Assignee: RMO, INC., Denver, CO (US)

(21) Appl. No.: 11/740,812

(22) Filed: Apr. 26, 2007

Related U.S. Application Data
(60) Provisional application No. 60/795,611, filed on Apr. 26, 2006.

(51) Int. Cl. A61C 3/00

(52) U.S. Cl. 433/17

(57) ABSTRACT

A convertible orthodontic bracket is disclosed, wherein an archwire slot therein has a removable slot covering, thereby allowing the bracket to serve as a buccal tube during a first stage of treatment and an edgewise bracket during a subsequent phase of treatment. The slot covering is removable by detaching the slot covering from the bracket body along one or more predetermined extents of weakness, wherein each such extent of weakness includes perforations or voids providing a passage between an exterior of the bracket and an interior of the first archwire slot.

### CROSS-REFERENCE TO RELATED APPLICATION

The present application claims the benefit of U.S. Provisional Patent Application No. 60/795,611 filed on Apr. 26, 2006, and entitled “ORTHODONTIC BRACKET WITH CONVERTIBLE BUCCAL TUBE”, the entire content of which is incorporated herein by reference in its entirety.

### FIELD OF THE INVENTION

The present disclosure is directed to an orthodontic bracket, and in particular, a convertible bracket with a cover that can be removed or otherwise modified in shape.

### BACKGROUND

Orthodontic brackets are widely used to align teeth through the application of forces selectively provided by interconnected archwires and accessories. Brackets are typically of metal, ceramic or composite construction and comprise a base interconnecting with a tooth, and a bracket main portion providing a slot and optionally, e.g., tie wings for use in realigning the tooth.

A convertible bracket is an appliance used by orthodontists to correct malpositioned teeth. In a convertible bracket, the buccal or cheek-facing side of the archwire slot is enclosed by a structure, such as a plate or cap, to form a tubular opening that is typically rectangular or trapezoidal in cross section. The plate or cap can be brazed, laser welded or spot-welded in place. Alternatively, the bracket body may have an integrally formed cover plate with lines of weakness formed by elongated frangible webs extending along the length of the archwire slot as disclosed in U.S. Pat. No. 4,927,362, the contents of which are incorporated herein by reference. In this way, the plate or cap can be removed to convert the tube to a conventional bracket during later stages of treatment. These perforations can also be fabricated by the use of water or other liquids via, e.g., jets for removing material in the same manner as when forming the original part. Such a cap may also be made from a different material than the material of the bracket body. Some possible bracket body and cap combinations may include combinations of one or more of: metal, ceramic, plastic, composite, or other precious metals. For example such a combination may include a metal bracket body with a plastic cap or a ceramic bracket body with a composite cap.

In orthodontic brackets, an archwire passes through a labially-opening, horizontal slot between, e.g., by one or more pair of opposing tie wings. Reference is made to U.S. Pat. No. 5,470,228 for further background information, with the content of U.S. Pat. No. 5,470,228 incorporated herein by reference. The archwire is preshaped and sized to provide the desired forces. Each bracket typically includes at least one tie wing pair having a gingivally extending tie wing and an occlusally extending tie wing. Once placed in the slot of one or more pair of tie wings, an archwire is typically restricted therein by a ligating device, such as a steel or elastomeric ligature.

Orthodontic treatment objectives and techniques continue to evolve, and the present disclosure represents significant advances in relation to the above-noted convertible orthodontic bracket while maintaining the utility and structural integrity of a buccal tube and an edgewise bracket.

### SUMMARY

A novel orthodontic bracket and method of use is disclosed herein, wherein the novel bracket has varying utilities both at the start of an orthodontic treatment and during later orthodontic treatment stages. The novel bracket includes a removable cover for an archwire slot of the bracket. During early stages of orthodontic treatment when the cover is in place, the cover creates a tube in the bracket which can assist in maintaining a desired relationship between the archwire and the slot, wherein the archwire is less prone to bind in or around the slot, and thus the archwire moves more freely therein (compared to a non-covered slot with a mechanism to hold the archwire in the slot). Subsequently, during a later stage of orthodontic treatment, the cover can be removed causing the convertible orthodontic bracket to function as a traditional edgewise bracket. Thus, in accordance with embodiments of the present disclosure, a novel convertible orthodontic bracket is provided, wherein the bracket provides structure to accommodate different modes of operation during different phases of patient treatment. In particular, the novel bracket includes perforations extending entirely through (or substantially so) a thickness of the cover so that the cover is attached to the remainder of the bracket by connecting portions that may be considered as “bridges” for attaching the cover to the bracket. Thus, such bridges provide predetermined lines or extents of weakness between the cover and the remainder of the bracket (referred to herein as the “bracket body”) for easy and predictable separation of the cover from the bracket body, wherein the following advantages are obtained over the prior art:
(a) The cover separates from the bracket body leaving a reduced extent of irregular surfaces and edges since only portions of the bridges may remain with the bracket body having such irregularities;
(b) Since the cover detaches predictably along the bridges (or at the ends of the bridges abutting the bracket body), the strength of the bracket without the cover is not compromised by the cover being detached from the bracket body whereby an undesired portion of the bracket body is also detached with the cover; and
(c) Since the cover detaches predictably along the bridges (or at the ends of the bridges abutting the bracket body), the entire cover is predictably removed. Thus, no or little additional extra work need be performed by an orthodontist to remove a portion of the cover that did not separate from the bracket body.

An embodiment of the novel convertible orthodontic bracket disclosed herein may include an integrally molded, cast, sintered or machined product comprising an orthodontic bracket body defining an archwire slot that is covered on the buccal side by a detachable which may be integral with the bracket body or attached thereto by brazing, gluing, etc. The bracket body opposite the buccal cover may comprise torque built into the bracket body or slot or both. Angulation and offset may also be built into one or both of the slot and base.

The occlusal and gingival sides of the cover may be, in one embodiment, joined to the bracket body by connecting portions interleaved with perforations, voids or otherwise weak material forming predetermined separation extents (generally, in the mesial-distal directions) along which the cover can be detached from the bracket body by, e.g., fracturing or breaking the connecting portions. In one embodiment, the thickness of the cover (in the direction of the slot depth) and the thickness of the connecting portions are substantially the same. In another embodiment, the cover plate may have variations in thickness, and/or the connecting portions may have variations in thickness or a thickness different from that of the cover.

The connection portions may include members or bridges that attach along the mesial and distal sides of the bracket slot. Such members may extend generally in the gingival-occlusal directions of the bracket and may be positioned on the cheek-facing surface of the bracket body. There may be any number of such members at any location along the mesial and distal direction. There may also be a small or large number of perforations (e.g., voids or cutouts) within the interface between the cover and the bracket body, such perforations interleaved with these members. For example, there may be as few as two perforations within the interface, or as many as, e.g., seven or more.

In accordance with at least one embodiment in the present disclosure, a novel orthodontic bracket is provided, the bracket comprising: (i) bracket body having a base adapted for direct or indirect attachment to a tooth, and a body portion extending from the base and providing an elongated archwire slot, and (ii) slot covering having a cover and connections for connecting the cover to the bracket body, wherein the cover extends across and closes or covers a buccal side of said archwire slot, such a cover being joined to the bracket body along opposite sides of the slot by the connections having perforations therebetween for forming one or more lines or extents of weakness (e.g., two lines or extents of weakness), whereby the cover can be removed from the bracket body along the perforated extents of weakness to uncover the slot. The connections forming the one or more extents of weakness preferably comprise metal alternating with the perforations. The metal may be preferably substantially of the same thickness as the cover and each perforation is preferably oblong, in the mesial-distal direction, and defining a passage from the exterior of the bracket to the interior of the slot. However, such perforations may also be any other shape such as circles, squares, rectangles, etc. Additionally, note that the body of the bracket may have at least one occlusally extending tie wing and at least one gingivally extending tie wing. Alternatively, the bracket body need not include any tie wings, or any other orthodontic structure extending away from the slot. Examples of such structures include a hook, tube, circular boss, etc. as one of ordinary skill in the art will understand.

The present disclosure describes a novel convertible orthodontic bracket, the bracket comprising:
(a) a base adapted for interconnecting with a tooth;
(b) a body portion extending from the base and defining a mesial-distal extending archwire slot, the body portion may have at least one pair of tie wings, wherein the archwire slot is between a gingival wing and an occlusal wing of the at least one pair, or may have one or no tie wings with or without another orthodontic structure (e.g., a hook); and
(c) a removable cover extending across at least a portion of the archwire slot and buccally closing at least a portion of the archwire slot.

In accordance with embodiments of the present disclosure, the bracket body may include three pairs of tie wings, wherein for each pair, there is a tie wing on an occlusal side of the bracket body, and one on the gingival side. More generally, embodiments of the novel convertible bracket may include cantilevered portions extending outward from an occlusal-gingival center line through the bracket, wherein such cantilevered portions may be tie wings, hooks, or other orthodontic bracket extensions. An embodiment of the novel bracket may further comprise at least one sloped surface at a mesial or distal opening of the archwire slot. Additionally, the archwire slot comprises three substantially planar surfaces within the width of the cover. Another embodiment of the present disclosure may include a bracket body portion with one or more archwire slots. The body portion may also contain notches, channels, grooves, or holes along the occlusal, gingival, mesial, and distal sides. The base of the novel convertible bracket may include a dovetail, wire mesh, or integral one piece base as disclosed in U.S. Pat. No. 6,846,178 incorporated herein fully by reference. Note that the base may also include flanges which may be used for welding the bracket upon an orthodontic band. In addition to various tie wing designs, the novel convertible bracket may also include any combination of hook designs, hook locations, and hook orientations.

In addition, a novel method of use is disclosed herein which includes a method of converting a bracket from a buccal tube to an edgewise bracket. Such a method may include the steps of:
(a) Attaching the bracket to a tooth during an orthodontic treatment, the bracket comprising: (i) a body portion extending from a tooth attaching base, the body portion comprising, e.g., one or more tie wings having an archwire slot thereinbetween, or no tie wings, or one or more other orthodontic structures such as a hook, etc, and (ii) a removable cover plate;
(b) Inserting an archwire into the archwire slot;
(c) Removing the cover plate at some time during a series of orthodontic treatments; and
(d) Ligating the archwire by attaching a ligating device to the bracket after inserting the archwire into the archwire slot after the removing step.

In accordance with embodiments of the novel method of use, the ligating device may be formed into a figure “8” as viewed in a mesial-distal direction along a width of the bracket. The ligating device may be alternatively placed around a center pair of tie wings only, or conventionally around all of the tie wings, or on one side of the outer most tie wings with respect to the mesial and distal sides, or around the outer most and middle wings together. Ligation of the archwire may also be performed by ligating around any other suitable structure of the bracket body including a hook.

In other embodiments of the present disclosure, the connections having perforations therebetween for forming one or more extents of weakness may be composed of ceramic or a composite (a composite such as a polymer plastic) alternating with holes formed in the ceramic or composite. The ceramic or composite may be substantially of the same thickness as the cover plate and the perforations may be oblong slots extending through the cover. The bracket body and cover can also be made out of plastic, ceramic, metal, or a precious metal or any combination thereof. For example, the bracket body may be composed of a metal bracket with a plastic cover or a ceramic bracket body with a composite cover. The fabrication of one or more of these parts can be made by Metal Injection Mold (MIM), Plastic Injection Mold (PIM), Ceramic Injection Mold (CIM), casting, laser welding, brazed, water jet, adhesives, etc.

In one embodiment of the novel convertible bracket, a second or auxiliary slot is provided parallel to a first archwire slot, such a second slot may be covered by a cover that is not designed to be removed. In another embodiment the second slot may be in any orientation (e.g., non-parallel) with respect to the first slot and may have a removable cover as well, Note that additional auxiliary slots may be included in the bracket which may also be have parallel and/or non-parallel orientations to the first archwire slot. One or more arch-wire/auxiliary slots in any combination of removable/non-removable covers can be provided, and such slots can be angled to one another.

In still other embodiments of the present disclosure, the cover can have a lesser mesial/distal length than the bracket's base and/or a corresponding covered archwire slot. In particular, the mesial/distal length of the cover may extend over at least 50% of the length of the slot 106 and less than 90%, and more preferably between 60% and 90% of the slot's length.

Additionally, the novel bracket disclosed herein may also include the features of U.S. patent application Ser. No. 11/695,555 filed Apr. 2, 2007 incorporated fully herein by reference, wherein the covered slot have a lining of an archwire friction reducing metal (e.g., gold) together with expanded or fluted slot ends for further reducing the friction between an archwire and the slot (in particular, an archwire binding friction).

Embodiments of the novel bracket disclosed herein may also be considered as improvements on the convertible buccal tube disclosed in U.S. Pat. No. 6,428,314 filed Apr. 20, 2001 which is fully incorporated herein by reference.

Embodiments of the novel bracket disclosed herein may also be considered to have various forms of indicia and/or patterns in the interface of the base surface that faces the tooth to which the bracket is to be attached. Disclosure of this aspect is disclosed in U.S. Pat. No. 6,846,178 entitled “Orthodontic Bracket Base Apparatus and Method of Manufacture” is incorporated herein by reference in its entirety. In addition, the content of U.S. Patent Application Publication No. 2005/0003320 A1 entitled “Edgewise Orthodontic Bracket with Character Base” is incorporated herein by reference in its entirety.

In yet other embodiments of the novel bracket, the mesial and distal ends of the archwire slot can be configured in an angled, sloped, or funnel shape to facilitate easier insertion of an archwire.

Another embodiment of the present disclosure may include a bracket or bracket body that can measure force exerted through an archwire.

Additional notable aspects of the novel convertible bracket are:
(a) The novel convertible bracket may include:
   a bracket body including: a base adapted for interconnecting to a tooth and a bracket portion extending from the base and defining an archwire slot having a length and having a width extending in an occlusal-gingival direction, said bracket portion further comprising at least one occlusally extending cantilevered portion and at least one gingivally extending cantilevered portion; and
   a slot covering attached to the bracket body, wherein the slot covering extends across the slot width for maintaining an archwire in the slot, the slot covering having a first plurality of connecting portions for attaching the slot covering to an occlusal bracket side of the slot, and a second plurality of connecting portions for attaching the slot covering to a gingival bracket side of the slot;
   wherein at least one of the first and second pluralities of connecting portions include at least two connecting portions having a perforation therebetween for forming a predetermined extent of weakness adjacent a side of the slot, wherein for disconnecting from the bracket body at least a part of the slot covering extending along the length of the slot, the at least two connecting portions are caused to cease to connect the part of the slot covering from the bracket body.
(b) The predetermined extent of weakness includes at least two perforations.
(c) The predetermined extent of weakness extends a majority of the length of the slot but may extend less than 90% of the length of the slot, and a majority of the predetermined extent of weakness is voids, wherein each void provides a passage between an exterior of the bracket and an interior of the slot.

Various embodiments of the present disclosure are set forth in the attached figures and in the detailed description provided hereinbelow and as embodied by the accompanying claims. It should be understood, however, that the present Summary section may not contain all of the novel aspects and novel embodiments claimed herein. Accordingly, the present Summary is not meant to be limiting or restrictive in any manner, and the disclosure herein is and will be understood by those of ordinary skill in the art to encompass obvious improvements and modifications thereto.

Other embodiments within the scope of the present disclosure will be clear to those of ordinary skill in the art after a review of the detailed description hereinbelow together with the accompanying drawings.

### BRIEF DESCRIPTION OF THE DRAWINGS

FIG. 1 shows a top perspective view of a convertible orthodontic bracket 100 in accordance with the present disclosure, wherein the cover 110 is connected to the bracket body 102. Note that the sidewalls 107 and/or the floor 108 may be covered with an archwire friction reducing material such as gold.

FIG. 2 shows another view of the convertible orthodontic bracket of FIG. 1.

FIG. 3 shows a substantially side view of another embodiment of the bracket 100.

FIG. 4 shows a top perspective view of the convertible orthodontic bracket of FIG. 3, with the cover 110 removed from the bracket body 102.

FIGS. 5 through 15 show additional embodiments of the novel convertible bracket disclosed herein. Note that the sidewalls 107 and/or the floor 108 may be covered with an archwire friction reducing material such as gold.

FIGS. 16 and 17 show, respectively, perspective and side views of a twin tie wing embodiment of the novel convertible bracket (identified as 100L). Note that the sidewalls 107 and/or the floor 108 may be covered with an archwire friction reducing material such as gold. Moreover, the floor 108 and the sidewalls 107 may be expanded or fluted at the ends of the slot 106 as described in U.S. patent application Ser. No. 11/695,555 filed Apr. 2, 2007.

FIGS. 18 and 19 show, respectively, perspective and side views of a twin tie wing embodiment of the novel convertible bracket (identified as 100m), wherein the bracket base 104 is flanged for attaching to, e.g., an orthodontic band (not shown). Note that the sidewalls 107 and/or the floor 108 may be covered with an archwire friction reducing material such as gold. Moreover, the floor 108 and the sidewalls 107 may be expanded or fluted at the ends of the slot 106 as described in U.S. patent application Ser. No. 11/695,555 filed Apr. 2, 2007.

### DETAILED DESCRIPTION

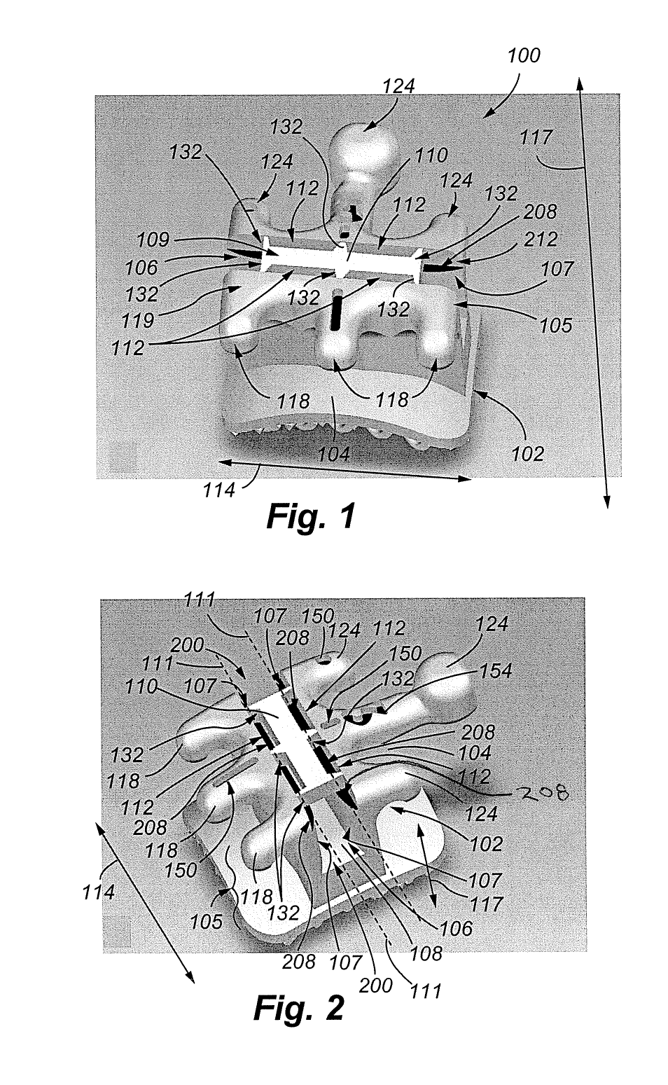

As illustrated in FIGS. 1 and 2, a convertible orthodontic bracket 100 is shown which includes:
(a) a bracket body 102 having a base 104 for interconnecting (either directly or indirectly) with a tooth, and extending from the base, a main portion 105 having an archwire slot 106 therein, the slot having sidewalls 107, and a floor 108 (FIG. 2), and
(b) a slot covering 109 for retaining an archwire within the slot 106, wherein the slot covering includes: a cover 110 for the slot 106, and connecting portions 132 for connecting the cover 110 to the bracket body 102.

The connecting portions 132 extend along the two outer side edges (in the direction of the slot 106) of the cover 110 to form two perforated extents of weakness generally co-linear with the axes 111, each such extent of weakness having at least one perforation or hole 112 extending entirely through the thickness of the cover 110 so that this cover is only attached to the bracket 100 by the connecting portions 132. Preferably, each of the perforations 112 is longer in the mesio-distal direction 114 than they are wide in the traverse occluso-gingival direction, and in particular each perforation may have a length approximately at least three times that of its width. However, various sizes and shapes of perforations optionally together with any thin or weakened areas of the connecting portions 132 can be used to address specific manufacturing and/or use requirements, without departing from the scope of the present disclosure. Thus, for example, such perforations may be square, round, or rectangular. However, a preferred shape of such perforation, as discussed below, is trapezoidal.

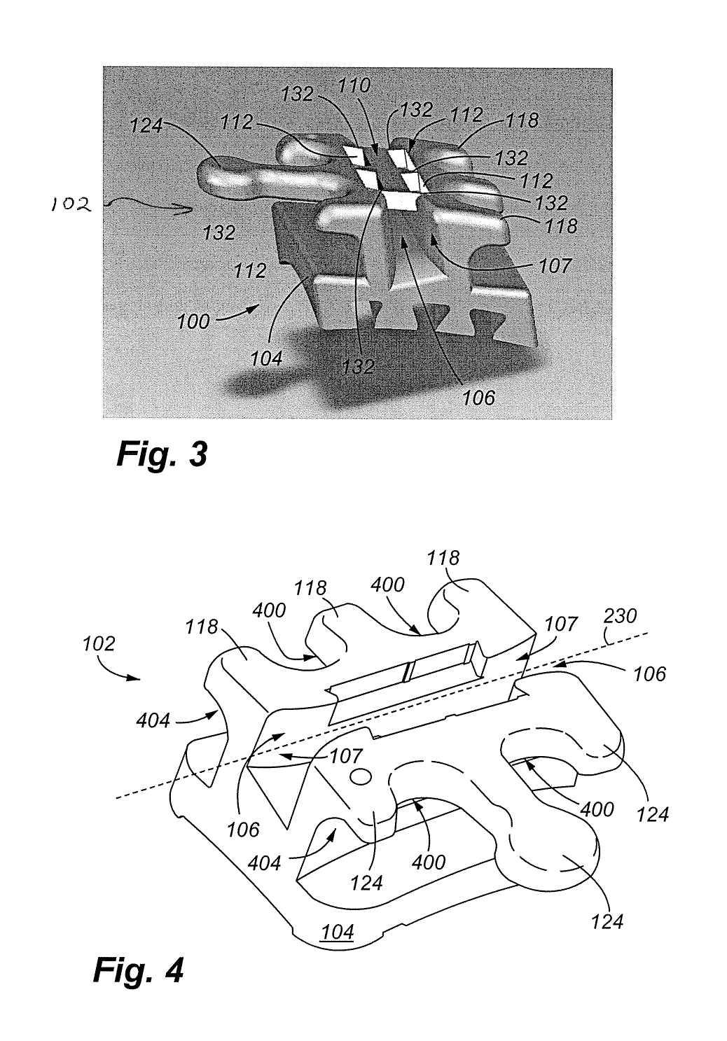

In one embodiment, the connecting portions 132 are integrally formed with and made of the same material as the cover 110 and have substantially the same thickness as the cover 110, wherein “thickness” refers to the linear dimension along the axis 117 (FIG. 2) corresponding with, e.g., the depth of the slot 106. However, in another embodiment, the connecting portions 132 may be less thick than the thickness of the cover 110. In one embodiment, such thinness of the connecting portions 132 may be due to the exposed or cheek facing surface 119 of the connection portions being recessed (not shown in FIGS. 1 and 2). Accordingly, in this embodiment, when the cover 110 is detached from the bracket 100 (along the lines of weakness), any irregularly shaped or non-smooth surfaces or edges where the connection portions 132 separated from the bracket 100 will be recessed into the bracket, and therefore less likely to be an irritation or require smoothing. In another embodiment, as shown in FIG. 3, the cover 110, the connecting portions 132, and the bracket body 102 may be formed as an integral unit, wherein each perforation 112 is formed in the a unitary combination of the bracket body 102 and the cover 110.

In at least some embodiments, the cover 110 may have a thickness of about 0.1 mm to about 5 mm. Note that the thickness of the cover 110 may vary according to the desired force to be applied for removing the cover from the bracket body 102. Additionally, note that the preferable range of forces for removal of the cover 110 is 5 lbs to 30 lbs (equivalently, 22 Newtons to 133 Newtons). Additionally, the cover 110 may extend over at least 50% of the length of the slot 106 and less than 90%, and more preferably between 60% and 90% of the slot's length. In general, it is preferable for the cover 110 to not extend the full length of the slot 106 since such a full length cover may make it harder for an orthodontist to thread an archwire into the slot. Note, however, that in one embodiment, the thickness of the cover 110 may decrease at least one of its longitudinal ends so that the corresponding slot cross section at the cover end is greater than the cross section of the slot at, e.g., the center of the length of the slot. Accordingly, in this later embodiment, the length of the cover 110 may extend substantially the full length of the slot 106; e.g., 90% to 100% of the slot length.

The base 104 can be employed in connecting the convertible orthodontic bracket 100 to a patient's tooth. Any suitable means of attachment, whether presently known or developed in the future, can be used to attach the convertible orthodontic bracket 100 to the patient's tooth (not shown). Accordingly, various methods for attaching the bracket 100 to the tooth may be employed, including direct bonding to a tooth, welding flanges onto a band which is then connected to a tooth, via a mesh base, etc.

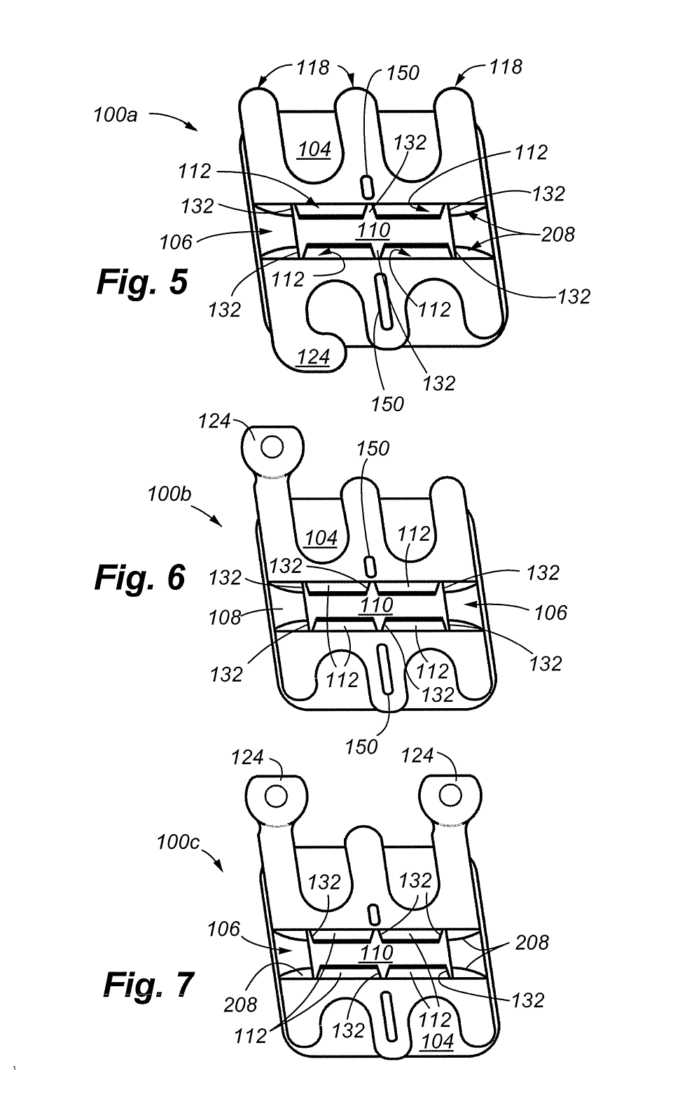

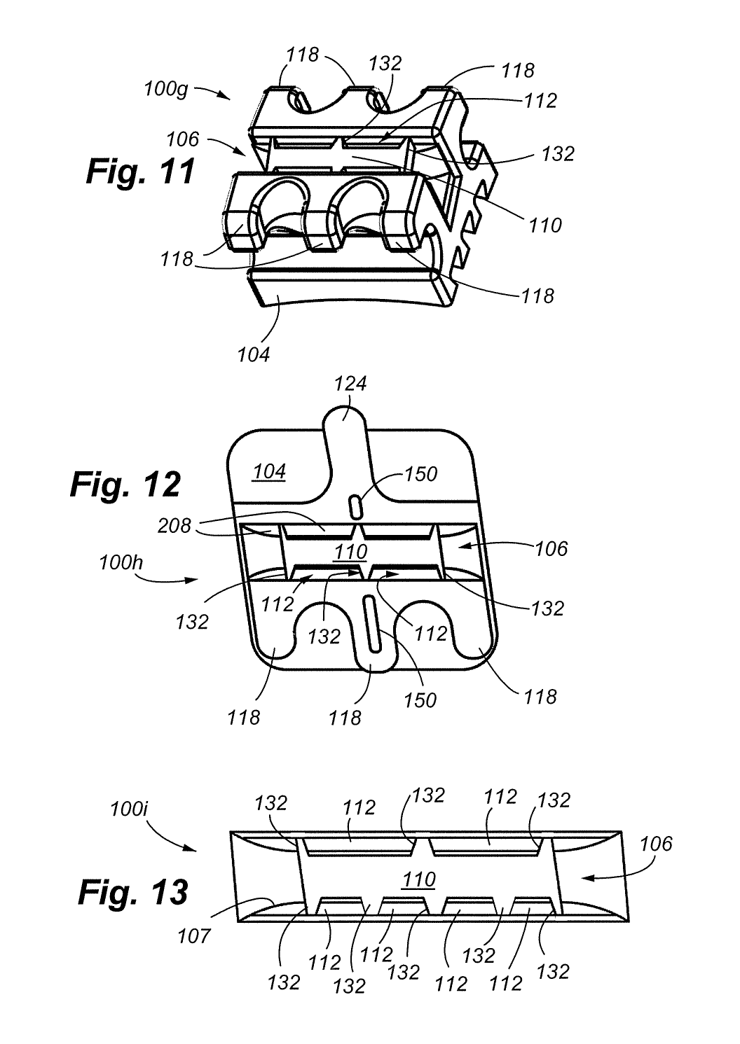

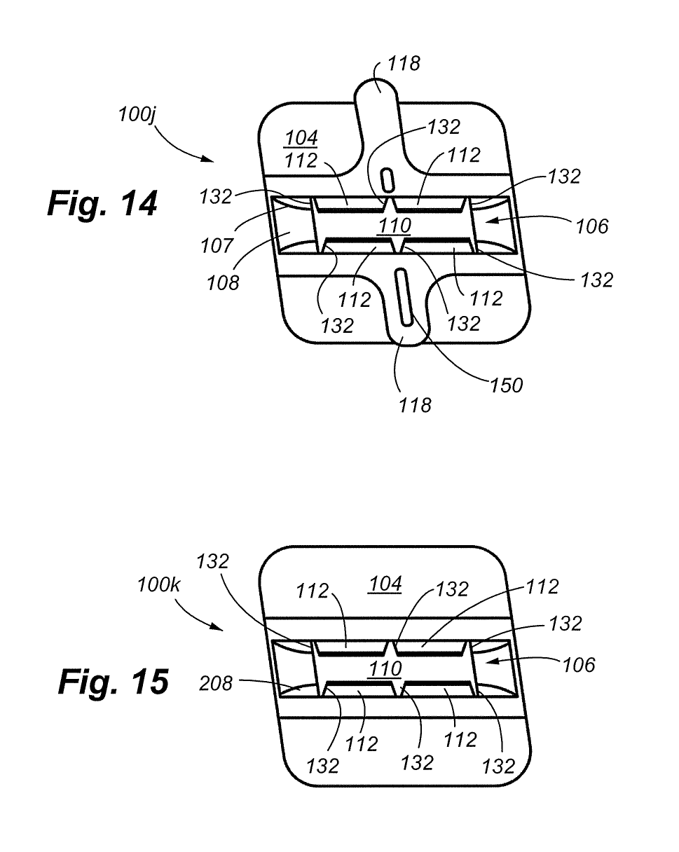

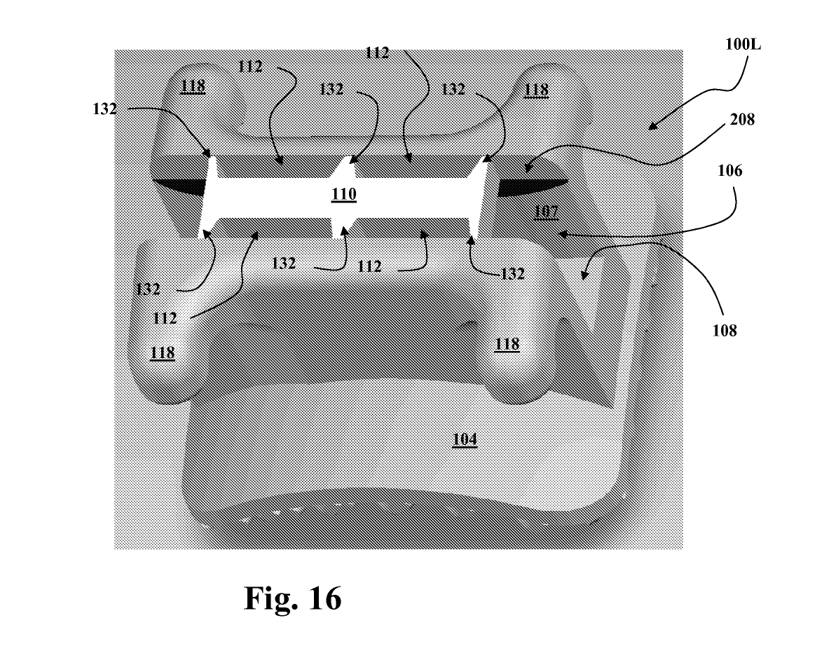

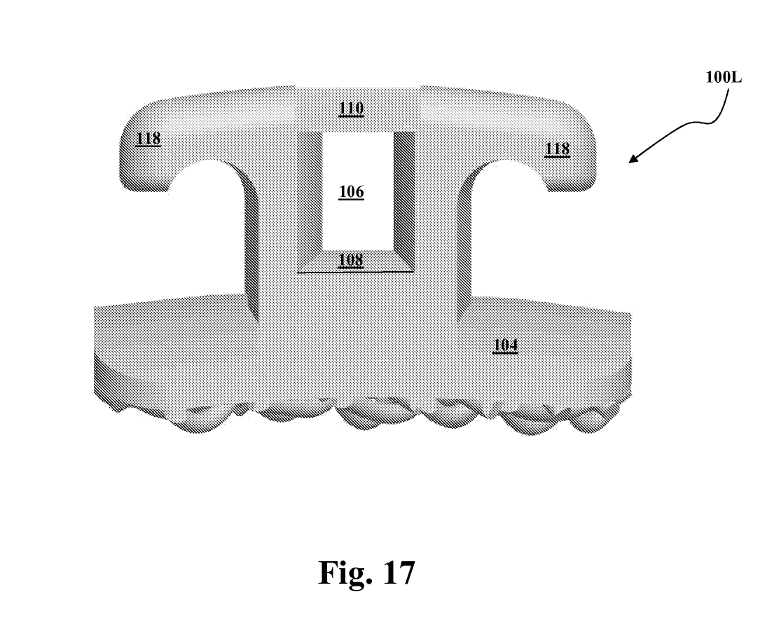

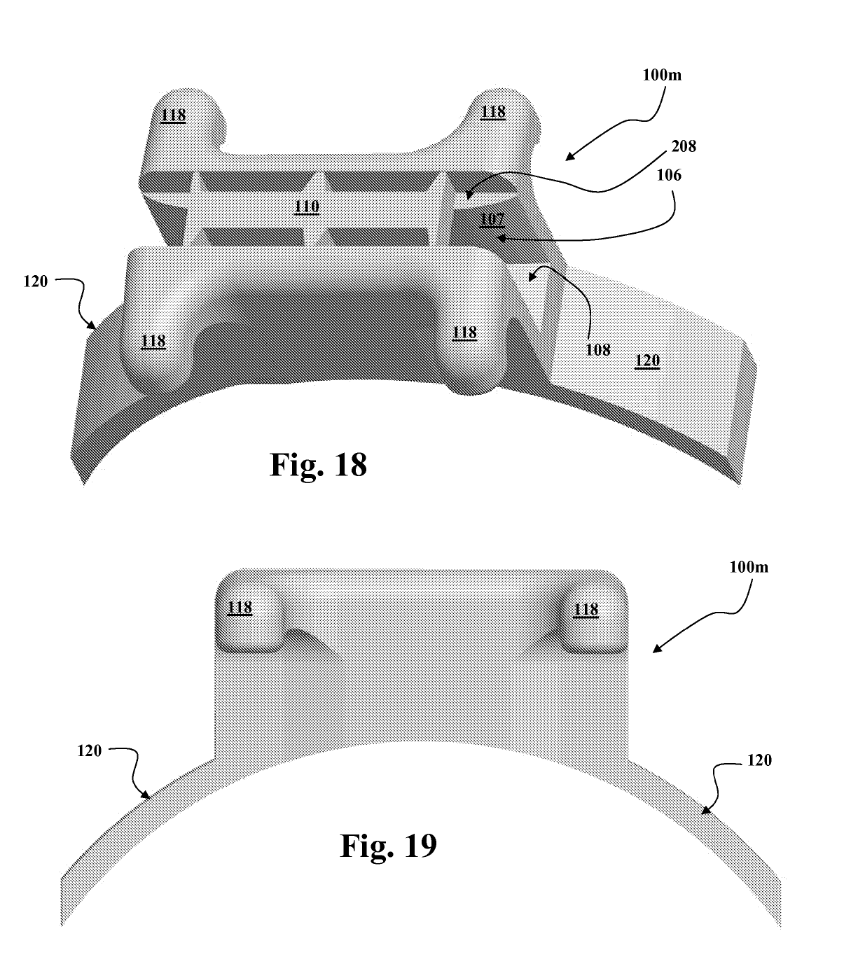

In the embodiment of FIGS. 1 and 2, the cover 110 is shown on a bracket body 102 having three tie wings 118 on one side (gingival or occlusal), and two tie wings 124 together with a central extended wing/hook 124 on the other side (gingival or occlusal) of the bracket body 102. However, the cover 110 or variations thereof may be provided on other types of slotted bracket bodies. For example, the brackets 100a through 100k, respectively shown in FIGS. 5-15 (and variations thereof) are within the scope of the present disclosure. Additionally, a twin tie wing embodiment of the novel convertible bracket (100L) is shown in FIGS. 16 and 17. Also, a further embodiment is shown in FIGS. 18 and 19, wherein in this embodiment, a twin tie wing bracket 100m is shown having curved flanges 120. The flanges 120 provide appropriate surface area and contour for attaching the bracket 100m to an orthodontic band (not shown) instead of attaching the bracket 100m directly to a tooth. Note that the sidewalls 107 and/or the floor 108 of any of the embodiments 100, and 100a through 100m may be covered with an archwire friction reducing material such as gold. Moreover, the floor 108 and the sidewalls 107 may be expanded or fluted at the ends of the slot 106 as described in U.S. patent application Ser. No. 11/695,555 filed Apr. 2, 2007.

In yet another embodiment, the bracket 100 (and/or brackets 100a-100k) may comprise a built-in torque.

Referring to FIG. 2, this figure more clearly shows the alignment indicia 150 and bracket type identification 154 also shown in FIG. 1. Additionally, FIG. 2 better shows the chamfered or fluted slot openings 200 preferably provided in one or both entrances to the archwire slot 106. Additionally, note that the floor 108 of the slot 106 may also slope toward the base 104 near a slot opening 200 to further increase one or both openings to the slot 106. Accordingly, when the archwire is inserted into the slot 106 via such an expanded opening 200, the threading of the archwire (not shown) through the archwire slot 106 is much easier. More particularly, since the entrance to the archwire slot 106 is larger than the archwire and is somewhat funnel shaped, easier threading of the archwire through the bracket 100 is provided for the orthodontist in much the same manner that a countersink simplifies the placement of a screw in a pre-drilled hole.

Note that FIGS. 1 and 2 also show a ledge 208 above each of the sidewalls 107. Each ledge 208 may be used for proper placement of the cover 110 when it is attached to its bracket body 102 above the slot 106. In particular, the cover 110 and its connecting portions 132 may be attached to the bracket body 102 (i.e., the bracket without the cover) by first positioning the cover and its connecting portions 132 on the ledges 208 and then (or thereby) securing each connecting portion 132 to a corresponding ledge wall 212 (FIG. 1) to which the connecting portion abuts. Alternatively/additionally, the connecting portions 132 may be secured to the ledges 208. Note that the securing of the cover 110 and its connecting portions 132 may be performed by brazing, using an adhesive, etc. as one of ordinary skill in the art will understand. Moreover, note that since the attachment of the connecting portions 132 to the ledge 208 and/or the ledge walls 212 occurs in only about 5% to 20% of the length of the slot 106, there is a substantial reduction in irregular surfaces, irregular or sharp edges, and a very reduced likelihood of portions of the bracket body 102 being removed with the cover 110 (and at least some part of the connecting portions 132). That is, since the perforations 112 are preferably longer than the connecting metal 132 there between. This aids in the separation of the cover plate 110 from the convertible orthodontic bracket 100. Accordingly, in at least some embodiments, the perforations 112 are preferably elongated apertures. The number and dimension of such apertures forming the perforations 112 can be varied; however, preferably there are more perforations 112 and/or a greater area of perforations 112 and/or weaknesses along a separation line or path than there is material between such apertures along the same line. In accordance with at least one embodiment of the present disclosure, one or more of the perforations 112 are trapezoidal in shape, with the longest parallel side along the outer distal ends of the connector portions 132, the shorter parallel edge towards the center of the cover plate 110, and the two nonparallel edges at the mesial-distal ends of the perforations 112. Note that such a trapezoidal configuration for each perforation 112 is advantageous in that when separating the cover 110 from the bracket body 102, it is much more likely that the separation will occur nearer to (or at) each juncture where the distal or free end of each of the connecting portions 132 abuts bracket body 102.

Preferably, the convertible orthodontic bracket 100 (or any one of the brackets 100a-100k) is manufactured by molding and sintering; however, the perforations 112 can alternatively be formed by laser techniques, etc.

In use, the convertible orthodontic bracket 100 (or any one of the brackets 100a-100k) is typically secured to a tooth by adhering the bracket 100 to a surface of the tooth. Alternatively, the bracket 100 may be secured to a tooth by connecting the bracket to a tooth band (not shown) that is then attached to a tooth. A terminal end of a conventional archwire is then fitted into the covered slot 106 of the bracket 100 (or any one of the brackets 100a-100k) for early-stage orthodontic treatment. Subsequently, in a later stage of treatment, the initial archwire is removed, and the cover 110 is removed from convertible orthodontic bracket 100 to convert the bracket 100 to an edgewise bracket wherein the slot 106 is buccally-open.

A technique for removing the cover plate 110 comprises use of a prying tool inserted in the archwire slot 106 openings 200 for shearing or breaking the cover 110 away from the bracket body 102. As one of ordinary skill in the art will understand, there are various other ways in which to remove the cover 110 from the convertible orthodontic bracket 100 (or any one of the brackets 100a-100k), including use of different metals, plastics, ceramics, polymers, etc., which have distinct physical characteristics that would allow for the separation of the cover from the rest of the bracket body 102. Although not shown, alternative methods to remove cover 110 include the provision of drawstring-like structures (not shown) which, when pulled, will separate one edge of the cover 110 from the rest of the bracket body 102. Still other techniques that may be employed include chemical dissolution of particular areas of the connecting portions 132 and/or the cover 110 to permit easy removal, laser techniques to separate the cover from the bracket body 102, etc. All of the above methods and techniques are within the scope of the present disclosure.

Referring now to FIG. 4, the convertible orthodontic bracket 100 of FIG. 3 is illustrated, wherein the cover plate 110 has been removed, e.g., by the orthodontic tool for entering the openings 200. Note that such a tool may break the connecting portions 132, disengage the connecting portions from the bracket body 102, or otherwise terminate the connections to the bracket body provided by the connecting portions. With the cover plate 110 removed, the interior of the archwire slot 106 can be seen, and bracket 100 is then utilized as an edgewise bracket.

The archwire slot 106 can be configured to have reliefs at the end of the sidewalls 107 and slot floor 108 for reducing the surface area contact with an archwire. However, in at least one preferred embodiment of the present disclosure, the gingival and occlusal side walls 107 and slot floor 108 are substantially flat and planar. Moreover, in at least one embodiment of the present disclosure, the gingival and occlusal side walls are substantially parallel between the mesial and distal ends of the cover 110.

Referring again to FIG. 4 and in accordance with embodiments of the present disclosure, after the cover plate 110 has been removed, it is useful to employ one or more ligatures to maintain the archwire (not shown) within the archwire slot 106. As illustrated, a first of one or more tie wings 118 extend from the gingival-occlusal center line 230 of the convertible orthodontic bracket 100. A second of one or more tie wings 124 extends in the opposite gingival-occlusal direction from the gingival-occlusal center line 230. Beneath and between each of the first tie wings 118, and the second tie wings 124, there are first and second ligature grooves 400, 404. A ligature can be wrapped about one or more of the tie wings 118 and one or more of the tie wings 124, wherein the ligature seats in at least one of the ligature grooves 400, 404 on each side of the center line 230, and also extends over the top of the archwire to keep the archwire in place. Thus, various ligature configurations and corresponding variations in the amount of ligature tension on an archwire can be provided as is described hereinbelow.

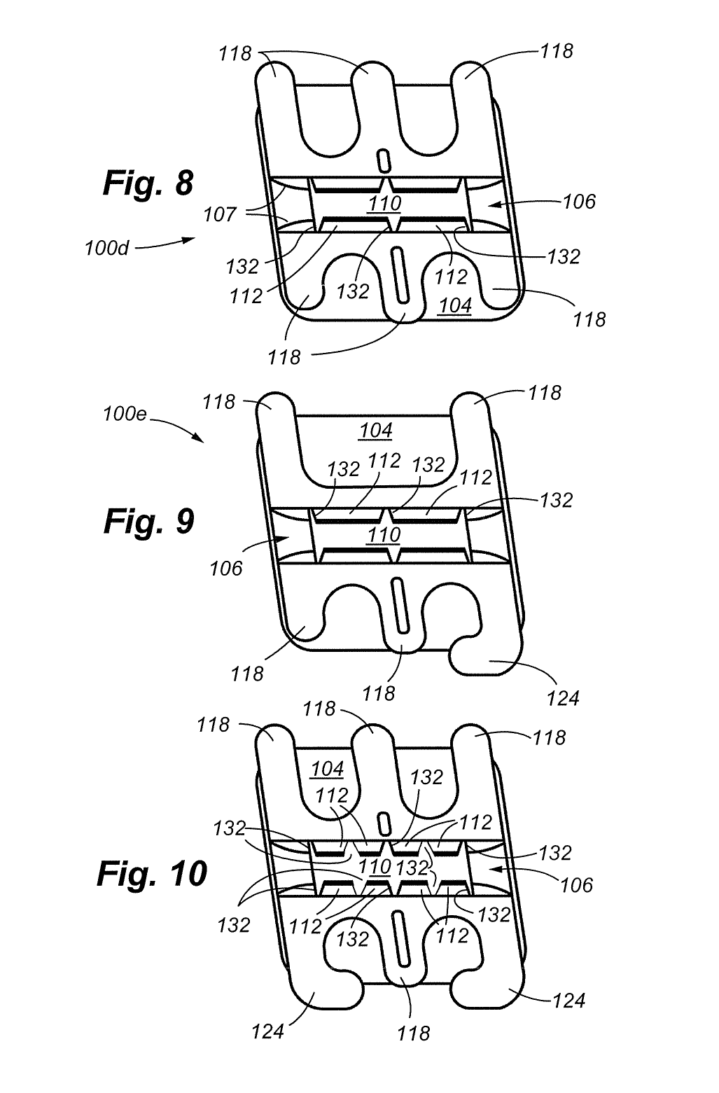

With three of tie wings on each of the occlusal and gingival sides of a bracket body 102 (i.e., the bracket 100 without at least the cover 110), the bracket body 102 provides a number of ligature configurations, whereby the amount of coupling friction between the archwire and the bracket can be controlled by the orthodontist by using the various possible ligature configurations. For example, by placing a ligature over the center tie wings only, the amount of coupling friction is relatively small. In contrast, by forming a “figure 8” around all of the tie wings, a maximum amount of coupling friction can be applied. Thus, the features of the convertible bracket 100 allow it to be used as a buccal tube in the early stages of treatment, while further offering the synergistic capability of having the bracket function as an edgewise bracket in later stages of treatment, wherein the orthodontist is able to apply minimal ligature pressure on the bracket during early phases of treatment using the convertible bracket 100 as an edgewise bracket, and greater ligature pressure during later phases treatment as an edgewise bracket.

Another embodiment of the novel convertible bracket includes at least two archwire slots 106, wherein such slots may be parallel and adjacent to one another, each extending in the mesial-distal direction. One or more of the slots 106 may be have a slot covering 109 as described hereinabove. Note that the material of the bracket body 102 between the two slots is sufficiently wide (between the slots) and strong to accommodate connecting portions 132 attaching to at least one side of the material. In one embodiment, such width may be in the range of 1.0 mm to 3.0 mm. Note that one of the archwire slots 106 may have a non-removable cover.

Those skilled in the art will appreciate that numerous changes and modifications may be made to the preferred embodiments of the disclosure and that such changes and modifications may be made without departing from the spirit of the disclosure. It is therefore intended that the appended claims cover all such equivalent variations as fall within the true spirit and scope of the disclosure.

What is claimed is:

1. A convertible orthodontic bracket, comprising:
a bracket body including: a base adapted for interconnecting to a tooth and a body portion extending from the base and defining an archwire slot having a length, and having a width extending in an occlusal-gingival direction; and
a slot covering attached to the bracket body, wherein the slot covering extends across the slot width for maintaining an archwire in the slot, said slot covering having a first plurality of connecting portions for attaching the slot covering to an occlusal bracket side of the slot, and a second plurality of connecting portions for attaching the slot covering to a gingival bracket side of the slot;
wherein at least one of the first and second pluralities of connecting portions include at least two connecting portions having a perforation therebetween for forming a predetermined extent of weakness adjacent a side of the slot, wherein for disconnecting from the bracket body at least a part of the slot covering extending along the length of the slot, the at least two connecting portions are caused to cease to connect the part of the slot covering from the bracket body;
wherein the mesial/distal length of the slot covering is between 50% and 90% of the length of the archwire slot; and
a ledge between at least one sidewall of the slot and the slot covering, wherein the ledge faces a side of the slot covering that faces interior to the slot.

2. The convertible orthodontic bracket of claim 1, wherein each of the first and second pluralities of connecting portions include at least two connecting portions having a perforation therebetween for forming a predetermined extent of weakness adjacent a side of the slot, wherein for disconnecting from the bracket body the part of the slot covering extending the length of the slot, the at least two connecting portions are caused to cease to connect the part to the bracket body;
wherein the mesial/distal length of the slot covering is between 60% and 90% of the length of the archwire slot.

3. The convertible orthodontic bracket of claim 2, wherein the predetermined extent of weakness for the first plurality of connecting portions extends an entire length of the slot covering along a side of the slot, and the predetermined extent of weakness for the second plurality of connecting portions extends an entire length of the slot covering along a different side of the slot.

4. The convertible orthodontic bracket of claim 3, wherein when the connecting portions of each of the first and second pluralities of connecting portions are caused to cease to connect the part to the bracket body, the part is entirely detached from the bracket body.

5. The convertible orthodontic bracket of claim 4, wherein when the part is entirely detached from the bracket body, substantially the entire width of the slot is exposed along the entire length of the slot.

6. The convertible orthodontic bracket of claim 1, wherein the at least two connecting portions are caused to cease to connect the part to the bracket body by breaking each of the at least two connecting portions.

7. The convertible orthodontic bracket of claim 1, wherein the predetermined extent of weakness includes at least two perforations.

8. The convertible orthodontic bracket of claim 7, wherein the predetermined extent of weakness extends substantially the length of the slot cover, and a majority of the predetermined extent of weakness is voids, wherein each void provides a passage between an exterior of the bracket and an interior of the slot.

9. The convertible orthodontic bracket of claim 1, wherein the connection portions for the predetermined extent of weakness compose less than 20% of the length of the slot.

10. The convertible orthodontic bracket of claim 9, wherein the connection portions for the predetermined extent of weakness compose between 5% and 20% of the length of the slot.

11. The convertible orthodontic bracket of claim 1, wherein the perforation is trapezoidal shaped.

12. The convertible orthodontic bracket of claim 1, wherein said body portion includes at least one occlusally extending cantilevered portion and at least one gingivally extending cantilevered portion.

13. The convertible orthodontic bracket of claim 1, wherein said body portion includes at least two occlusally extending cantilevered portions, and at least two gingivally extending cantilevered portions.

14. The convertible orthodontic bracket of claim 1, wherein said body portion includes three occlusally extending cantilevered portions and three gingivally extending cantilevered portions.

15. The convertible orthodontic bracket of claim 14, wherein at least most of the cantilevered portions include a tie wing for fitting a ligature thereto when the part of the slot covering is detached from the bracket body.

16. A convertible orthodontic bracket, comprising:
a bracket body including: base adapted for direct or indirect attachment to a tooth, a bracket body extending from the base, and defining an elongated first archwire slot, the first slot having a length and opposing sides extending the length of the first slot;
wherein said the bracket body includes at least one occlusally extending cantilevered portion and at least one gingivally extending cantilevered portion; and
a slot covering attached to the bracket body, wherein the slot covering extends across and closes at least part of said first archwire slot, said slot covering being integrally joined to the bracket body along each side of the first archwire slot by a corresponding extent of weakness extending substantially parallel with the side;
wherein each extent of weakness includes at least two voids and at least two connection portions with one of the connection portions being between the two voids, said connection portions for attaching the slot covering to the bracket body, each of the voids providing a passage between an exterior of the bracket and an interior of the first archwire slot; and
wherein the mesial/distal length of the slot covering is between 50% and 90% of the length of the archwire slot.

17. The convertible orthodontic bracket of claim 16, wherein for at least one of the extents of weakness, the connection portions therefore have a total length along the at least one extent of weakness that is less than 20% of the length of the slot.

18. The convertible orthodontic bracket of claim 17, wherein the connection portions for the at least one extent of weakness have a total length along the at least one extent of weakness that is between 5% and 20% of the length of the slot.

19. The convertible orthodontic bracket of claim 16, wherein at least most of the voids are trapezoidal shaped, wherein the longest side of each trapezoidal shaped void is closer to the bracket body than an opposing side of the trapezoidal shaped void.

20. The convertible orthodontic bracket of claim 16, further comprising a chamfered opening to the first archwire slot.

21. The convertible orthodontic bracket of claim 16, further including a second archwire slot that is parallel and adjacent to the first archwire slot, wherein the second archwire slot is covered by a second slot covering.

22. The convertible orthodontic bracket of claim 16, further including a second auxiliary slot that is non-parallel to the first archwire slot, wherein the second archwire slot is covered by a second slot covering.

23. A method of converting bracket from a buccal tube to an edgewise bracket, comprising:
attaching the bracket to a tooth, the bracket comprising a bracket body having a base, the bracket body also defining a mesial-distal extending archwire slot, the bracket further including a removable slot covering attached to the bracket body, wherein the slot covering extends across a width of the slot for maintaining an archwire in the slot, said slot covering having a first plurality of connecting portions for attaching the slot covering to an occlusal bracket side of the slot, and a second plurality of connecting portions for attaching the slot covering to a gingival bracket of the slot;
wherein the mesial/distal length of the slot covering is between 50% and 90% of the length of the archwire slot;
wherein for at least two connection portions of the first plurality of connection portions there are at least two voids with one of the at least two connection portions being between the two voids, each of the voids providing a passage between an exterior of the bracket and an interior of the archwire slot; and
removing said cover by causing each of the first and second plurality of connecting portions to disconnect from the bracket body.

24. The method of claim 23, wherein the bracket body further includes at least one pair of tie wings with the archwire slot between said at least one pair of tie wings, and further including a step of ligating an archwire in the slot after the cover is removed.

25. The method of claim 23, further comprising a step of inserting an archwire into said archwire slot before said removing step.

26. The method of claim 24, wherein the step of ligating includes configuring a ligating device into a figure “8” as viewed in a mesial-distal direction along a width of the bracket.

27. The method of claim 24, wherein the step of ligating includes configuring a ligating device into one of a plurality of configurations, wherein each of the configurations provides a different ligating force for holding the archwire in the slot.

28. A convertible orthodontic bracket, comprising:
a bracket body including: a base adapted for interconnecting to a tooth and a body portion extending from the base and defining an archwire slot having a length, and having a width extending in an occlusal-gingival direction; and
a slot covering attached to the bracket body, wherein the slot covering extends across the slot width for maintaining an archwire in the slot, said slot covering having a first plurality of connecting portions for attaching the slot covering to an occlusal bracket side of the slot, and a second plurality of connecting portions for attaching the slot covering to a gingival bracket side of the slot;
wherein at least one of the first and second pluralities of connecting portions include at least two connecting portions having a perforation therebetween for forming a predetermined extent of weakness adjacent a side of the slot, wherein for disconnecting from the bracket body at least a part of the slot covering extending along the length of the slot, the at least two connecting portions are caused to cease to connect the part of the slot covering from the bracket body; and
a ledge between at least one sidewall of the slot and the slot covering, wherein the ledge faces a side of the slot covering that faces interior to the slot.
